(19) United States
(12) Patent Application Publication
(10) Pub. No.: US 2006/0143648 A1
(43) Pub. Date: Jun. 29, 2006

(54) Television receiver and control method for the same

(75) Inventor: Kazuhito Shinokawa, Ota-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/312,440

(22) Filed: Dec. 21, 2005

(30) Foreign Application Priority Data
Dec. 28, 2004 (JP) 2004-380300

(51) Int. Cl. H04N 7/16

(52) U.S. Cl. 725/25; 725/28

(57) ABSTRACT

A television receiver includes a recorder which records block log information relating to the screen block to a recording medium in relation to a first channel, when the first channel displayed on the display unit is in a screen block state, and a controller which reads out the block log information of the first channel from the recording medium and performs screen block of a program displayed on the display unit, based on the block log information, when the first channel is tuned after a second channel different from the first channel is tuned from the first channel by the tuning unit.

### CROSS-REFERENCE TO RELATED APPLICATIONS

This application is based upon and claims the benefit of priority from prior Japanese Patent Application No. 2004-380300, filed Dec. 28, 2004, the entire contents of which are incorporated herein by reference.

### BACKGROUND OF THE INVENTION

1. Field of the Invention

The present invention relates to a television receiver and a control method for the same for performing a viewing restriction to a concerned program by using rating information multiplexed on a television broadcast signal.

2. Description of the Related Art

In recent years, a certain type of television receiver has a V chip to cut, for example, a program whose viewing by a child is not desired by a parent by using rating information multiplexed on the television broadcast signal to indicate the extreme of program content. The V chip is a microchip device not to display a scene of extreme violence and extreme in portrayal of sex onto a display screen. And the V chip has a function of managing the concerned scene not to be viewed freely by means of a secret number registered in the television receiver in advance.

The television receiver decodes the rating information superimposed on the twenty-first line of a vertical blanking interval to be transmitted and collates it with the prescribed rank of viewing restriction which is preset in the television receiver to determine whether or not to the concerned scene should be displayed on a display screen. If the decoded rating information exceeds the view restriction, the broadcast receiver blocks the screen and, usually, blackens pictures and mutes sounds. Further, the rating information is transmitted for each channel.

By the way, since the television receiver receives the rating information at every channel, after tuning of a channel desired to be viewed, a prescribed time is needed for the broadcast receiver to detect the superimposed data, make the decoded information clear and decide whether or not the scene should be displayed on the screen. For example, in a state that the screen for the currently viewed channel is blocked, when the broadcast receiver tunes another channel through a remote-controlled operation by a viewer and operates to return the former channel again, the broadcast receiver displays a picture firstly in order to enhance responsibility and blocks the screen again in accordance with a result of decoding of the rating information. During a standby time until the screen is blocked, even the program of which the viewing by the child is not desired by the parent and the picture should be screen-blocked is displayed in a moment.

Therefore, a viewing restriction device capable of recognizing whether the screen should be blocked or not prior to receive the television broadcast signal by utilizing an electronic program guide (EPG) has been proposed conventionally (for example, Jpn. Pat. Appln. KOKAI Publication No. 2003-110953).

However, the forgoing viewing restriction device blocks screens for each program indicated by the EPG and does not block the screen for a certain scene in a program. The foregoing viewing restriction device determines whether the screen of the concerned program should be blocked or not at the time of a program reservation. The foregoing viewing restriction device then does not block the screen immediately if the program tuned by means of the remote-controlled operation is a program to be screen-blocked in the middle of actual viewing of the program.

### BRIEF SUMMARY OF THE INVENTION

Accordingly, an object of the present invention is to provide a television receiver and a control method for the same for immediately blocking a screen if a program is a target to be screen-blocked.

According to an aspect of the present invention, there is provided a television receiver configured to extract rating information indicating a degree of extreme of a program content corresponding to a channel tuned by a tuning unit among television broadcast signals in a plurality of channels, compare the rating information to pre-registered rating information and perform screen block to make the program displayed on a display unit again impossible to be viewed, based on a comparison result, comprising: a recorder which records block log information relating to the screen block to a recording medium in relation to a first channel, when the first channel displayed on the display unit is in a screen block state; and a controller which reads out the block log information of the first channel from the recording medium and performs screen block of a program displayed on the display unit, based on the block log information, when the first channel is tuned after a second channel different from the first channel is tuned from the first channel by the tuning unit.

According to another aspect of the present invention, there is provided a television receiver comprising a first receiving unit to extract rating information indicating a degree of extreme of a program content corresponding to a channel tuned by a tuning unit among television broadcast signals in a plurality of channels, compare the rating information to pre-registered rating information and perform screen block so as to make the corresponding program displayed on a display unit impossible to be viewed on the basis of a comparison result; and a second receiving unit to extract rating information corresponding to a channel different form that of the first channel and compare the rating information to the pre-registered rating information comprising: a recorder which records block log information relating to screen block in a recording medium in relation to the first channel when a program in the first channel displayed onto the display unit is in a screen block state; a controller which reads out the block log information of the first channel from the recording medium and performs screen block of a program displayed on the display unit, based on the block log information, when the first channel is tuned after a second channel different from the first channel is tuned by the tuning unit; and an updating unit to update a recorded content of the block log information on the recording medium after recording of the block log information by the recorder, based on a comparison result of rating information acquired from an unused receiving unit among the first and the second receiving units.

According to yet another aspect of the present invention, there is provided a control method for television receiver which extracts rating information indicating a degree of extreme of a program content corresponding to a channel tuned by a tuning unit among television broadcast signals in a plurality of channels, compares the extracted rating information to pre-registered rating information and performs screen block to make a program displayed on a display unit impossible to be viewed, based on a comparison result, comprising: recording block log information relating to screen block to a recording medium in association with a first channel when the first channel displayed on the display unit is in a screen block state; and reading out the block log information of the first channel from the recording medium and performing screen block of a program displayed on the display unit, based on the block log information, when the first channel is tuned after a second channel different from the first channel is tuned from the first channel by the tuning unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram showing a first embodiment of a television receiver regarding the present invention;

FIG. 2 is an exemplary screen view showing for explaining operations when a channel of which the screen has been blocked is tuned again resulting from a channel change;

FIG. 3 is an exemplary flowchart showing screen block control procedures by a control unit in the first embodiment;

FIG. 4 is an exemplary screen view for explaining an example of operations when a channel of which the screen which has been formerly blocked is tuned after a short lapse of time;

FIG. 5 is an exemplary screen view for explaining an example of operations when a channel of which the screen has been formerly blocked is tuned in after a long lapse of time;

FIG. 6 is an exemplary block diagram showing a second embodiment of the television receiver regarding the present invention; and

FIG. 7 is an exemplary flowchart showing update control procedures by a control unit in the second embodiment.

### DETAILED DESCRIPTION OF THE INVENTION

Hereinafter, embodiments of the present invention will be explained by referring the drawings in details.

### First Embodiment

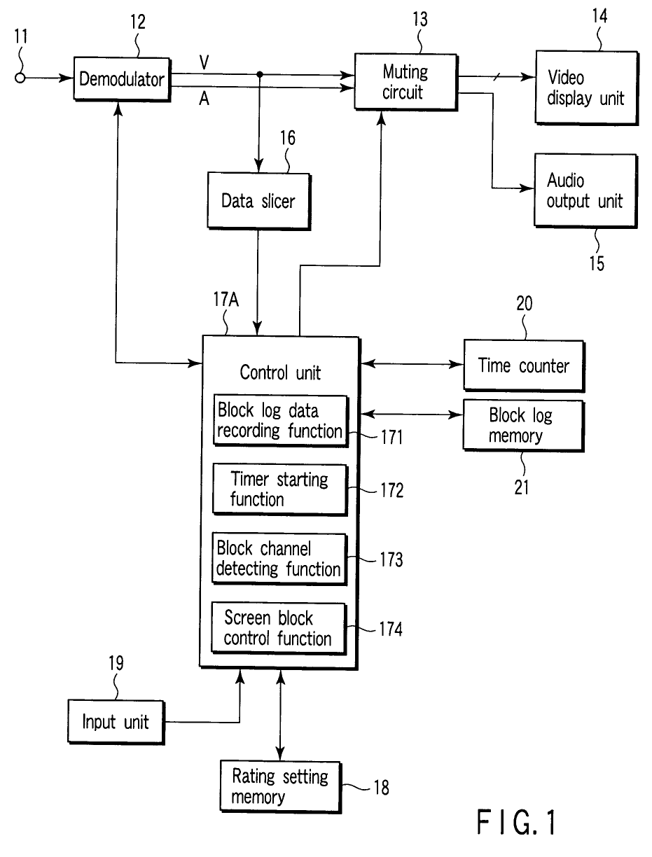

FIG. 1 is the exemplary block diagram showing the first embodiment of the television receiver regarding the present invention.

A television broadcast signal broadcasted from a broadcast station (not shown) is received at an antenna (not shown) then supplied to a demodulator 12 via an input terminal 11. The demodulator 12 demodulates a television broadcast signal of a tuning-instructed channel to reproduce a video signal V and an audio signal A and the video signal V is supplied to a video display unit 14 through a muting circuit 13. Therefore, the video display unit 14 displays a received picture. The audio signal A is supplied to an audio output unit 15 through the muting circuit 13 so as to be audio-reproduced.

On the other hand, the video signal V output from the demodulator 12 is supplied to a data slicer 16. The data slicer 16 slices the video signal V to decode rating information superimposed on the twenty-first line in a vertical blanking interval and outputs the decoded rating information to a control unit 17A.

A rating setting memory 18, an input unit 19, a time counter 20 and a blocking log memory 21 are connected to the control unit 17A. Among these parts, the input unit 19 is used by a user to input a variety of operation instructions such as channel specifying, etc., to the television receiver. And the input unit 19 is also used by the user to input a registration instruction of rating setting information relating to a program desired for a viewing restriction. Here, when the registration instruction of the rating setting information is input, the control unit 17A stores the rating setting information which is input thereto in the rating setting memory 18.

The control unit 17A then tuning-instructs to the demodulator 12 in accordance with the instruction from the user through the input unit 19 to compare the rating information decoded by the data slicer 16 to the rating setting information stored in the rating setting memory 18. And the control unit 17A controls the muting circuit 13 to stop screen blocking when the rating information does not exceed the rank of the rating setting information. Otherwise stated, the control unit 17A controls the muting circuit 13 to block the screen. The muting circuit 13 then supplies a black screen signal to the video display unit 14 to display a black picture and also supplies a silent signal to the audio output unit 15.

By the way, the control unit 17A has a block log data recording function 171, a timer starting function 172, a block channel detecting function 173 and a screen block control function 174 as new functions in the present invention in addition to usual functions relating to receiving display operations of the television broadcast signal.

The block log data recording function 171 stores block log information relating to screen block in association with the corresponding channel when other channel is tuned in a screen block state. Further, the block log memory 21 is formed of an information rewritable nonvolatile memory.

The timer starting function 172 starts, namely reset, the time counter 20 when tuning is changed from the channel in the screen block state to other channel. The time counter 20 counts a time required from decoding of rating information by the data slicer 16 until execution of the screen block by the muting circuit 13, for example, five seconds.

The block channel detecting function 173 detects whether or not the channel to be screen-blocked is tuned before the elapse of five seconds counted by the time counter 20 on the basis of the recording content in the block log memory 21.

When it is detected that the channel is changed to the formerly blocked channel, the screen block control function 174 reads out the block log information from the block log memory 21. And the screen block control function 174 controls the muting circuit 13 so as to perform the screen block, based on the block log information. And when five-second has elapsed, the screen block control function 174 controls the muting circuit 13 so as not to block the screen.

Next, operations in the forgoing configuration will be explained.

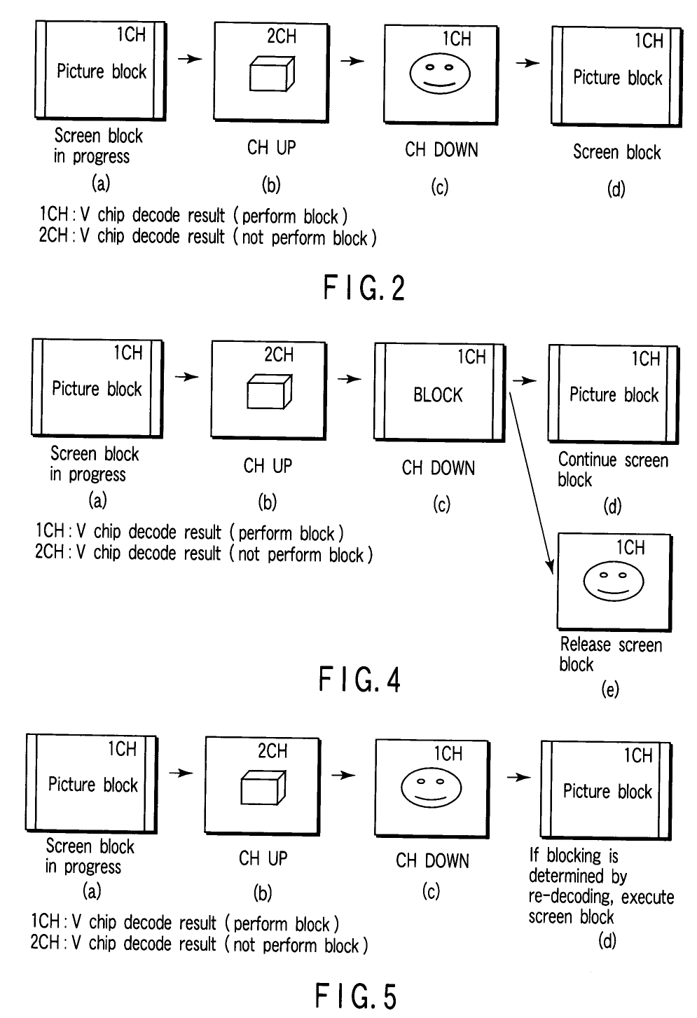

It is assumed that, for example, the user is in the viewing of a first channel as shown at (a) in FIG. 2. The first channel is now in the middle of the screen block. After the channel is changed so that a second channel is tuned as shown at (b) in FIG. 2, if the first channel is tuned again as shown at (c) in FIG. 2, a picture of the first channel is displayed at first. And if it is determined that the newly received rating information exceeds the rating setting information stored in the rating setting memory 18 in accordance with the determination after rating information is newly received and decoded, the screen block control function 174 blocks the screen of the first channel as shown at (d) in FIG. 2.

Therefore, there is the problem that, if the user quickly repeats operations of channel changes, pictures should be blocked are displayed in a staccato fashion.

Accordingly, in the first embodiment of the invention, the television receiver 1 is configured to store the log that the screens of the first channel have been blocked in the log memory 21 and than resets (t=0) the time counted by the time counter 20.

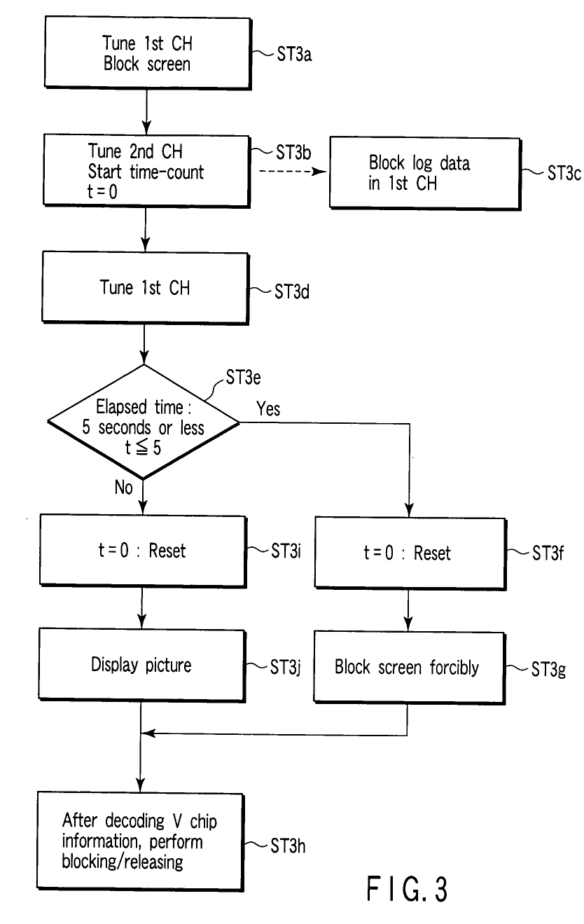

FIG. 3 is an exemplary flowchart showing screen block control procedures by the control unit 17A.

At first, in the screen block state of the tuned first channel and when the user changes the first channel to the second channel, the control unit 17A makes a sift from a step ST3a to a step ST3b to reset the time counter 20 and records the log information showing that the screen has been blocked in the block log memory 21 in association with the first channel (step ST3c).

Next, it is assumed that the user has changed the channel from the second channel to the first channel. The control unit 17A then refers the block log memory 21 to recognize the fact that the first channel has been in the screen block state (step ST3d) to determine whether or not the time to be counted by the counter 20 is not more than five seconds (step ST3e).

Here, if the time counted by the time counter 20 is not more than five seconds (Yes, in step ST3e), the control unit 17A resets the time counter 20 (step ST3f) and controls the muting circuit 13 so as to block the screen (step ST3g).

After this, the control unit 17A controls the muting circuit 13, based on the newly received rating information decoded from a video signal resulting form demodulation of the first channel (step ST3h). Here, if the newly received rating information exceeds the rating setting information stored in the rating setting memory 18, the control unit 17A continues the screen block as shown at (d) in FIG. 4, otherwise stated, releases the screen block as shown at (e) in FIG. 4.

On the contrary, if the time counted by the time counter 20 exceeds five seconds (No, in step ST3e), the control unit 17A resets the time counter 20 (step ST3i), controls to stop the muting circuit 13 to output the video and audio of the first channel as usual as shown at (c) in FIG. 5 (step ST3j).

At this time, when the newly received rating information exceeds the rating setting information stored in the rating setting memory 18, the control unit 17A blocks the screen again as shown at (d) in FIG. 5.

As mentioned above, in the foregoing first embodiment, when the currently viewed channel is in the screen block state and is changed into another channel, the control unit 17A records the block log information relating to this screen block in the block log memory 21 in relation to the blocked channel then reads out the block log information of the channel from the block log memory 21 to control the muting circuit 13 so as to execute the screen block of the channel, based on the block log information.

Accordingly, even if channel is changed and the channel of which the screen has been formerly blocked is tuned again, the control unit 17A can immediately execute the screen of the corresponding channel by using the block log information stored in the block log memory 21.

In the foregoing first embodiment, a time required from extracting the rating information by the data slicer 16 until execution of the screen block by the muting circuit 13 is counted by the time counter 20, so that if the channel of which the screen has been formerly blocked is tuned before the elapse of the time counted by the counter 20 after the channel has been changed from the screen block state, the control unit 17A executes quick the screen block by using the block log information stored in the block log memory 21. Then, the control unit 17A can perform optimum screen block for each elapsed time of channel changes as a manner that the control unit 17A does not perform the screen block if the channel of which the screen has been formerly blocked is tuned after the elapse of the time counted by the time counter 20.

Furthermore, in the foregoing first embodiment, the block log information is stored in the block log memory 18 only in the case that another channel is tuned in the screen block state, so that the broadcast receiver 1 can prevent the block log memory 18 from being used unnecessarily. The broadcast receiver 1 thereby can enhance an effective use rate of the block log memory 18.

### Second Embodiment

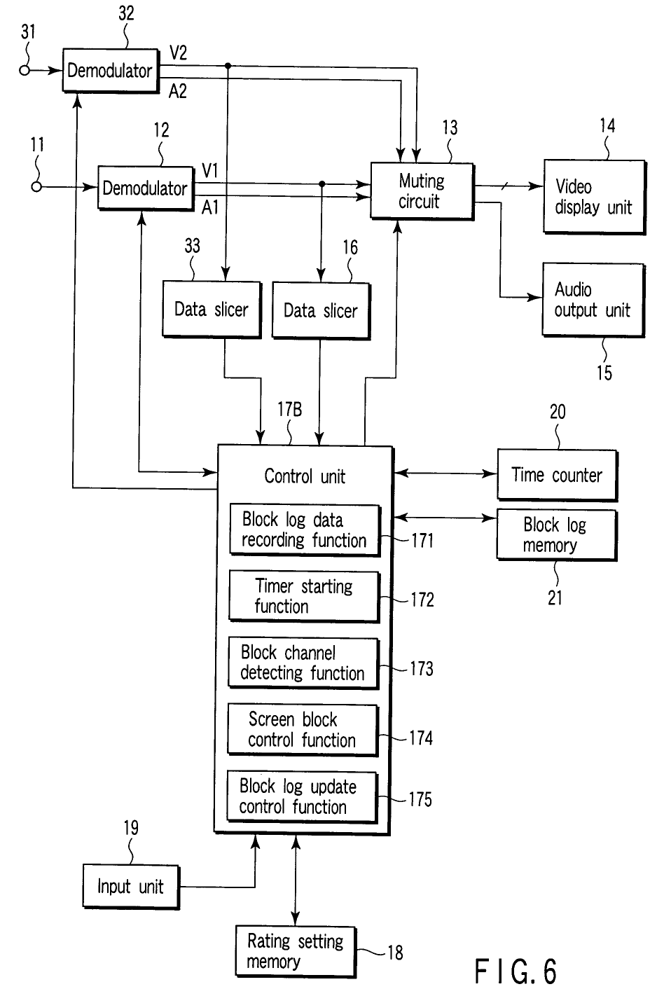

FIG. 6 is the exemplary block diagram showing the second embodiment of the television receiver regarding the present invention. In FIG. 6, the same parts as those of FIG. 1 is denoted by the same marks as those of FIG. 1 and the detailed explanation thereof will be eliminated.

In the second embodiment, the broadcast receiver 1 further comprises an input terminal 31, a demodulator 32 and a data slicer 33. The television broadcast signal broadcasted from the broadcast station (not shown) is received by the antenna (not shown) then supplied to the demodulator 12 through the input terminal 11 and also supplied to the demodulator 32 through the input terminal 31.

The demodulator 32 demodulates the television broadcast signal of the tuned and instructed channel to reproduce a video signal V2 and an audio signal A2 and supplies them to the muting circuit 13.

The muting circuit 13 supplies the video signals V1 and V2 output from each demodulator 12 and 32, respectively, to the video display unit 14 to display them and supplies the audio signals A1 and A2 output from each demodulator 12 and 32, respectively, to the audio output unit 15 to acoustically reproduce them in a double screen display mode in accordance with user's instructions. On the other hand, the muting circuit 13 supplies the video signal V1 output from either of the demodulators 12 and 32 to the video display unit 14 to display them and supplies the audio signal A1 output from either of the demodulators 31 and 32 to the audio output unit 15 to acoustically reproduce it in a single screen display mode.

On the other hand, the video signal V2 output from the demodulator 32 is supplied to the data slicer 33. The data slicer 33 slices the video signal V2 and decodes the rating information multiplexed on the twenty-first lime of the vertical black interval to output the decoded rating information to a control unit 17B.

By the way, the control unit 17B has a block log update control function 175 as a control function regarding the present invention. The block log update control function 175 makes an unused demodulator 12 or 32 tune the channel meeting with the block log information stored in the block log memory 21 and updates the block log information stored in the block log memory 21, based on the output from the data slicer 33.

Next, operations of the foregoing configuration will be explained.

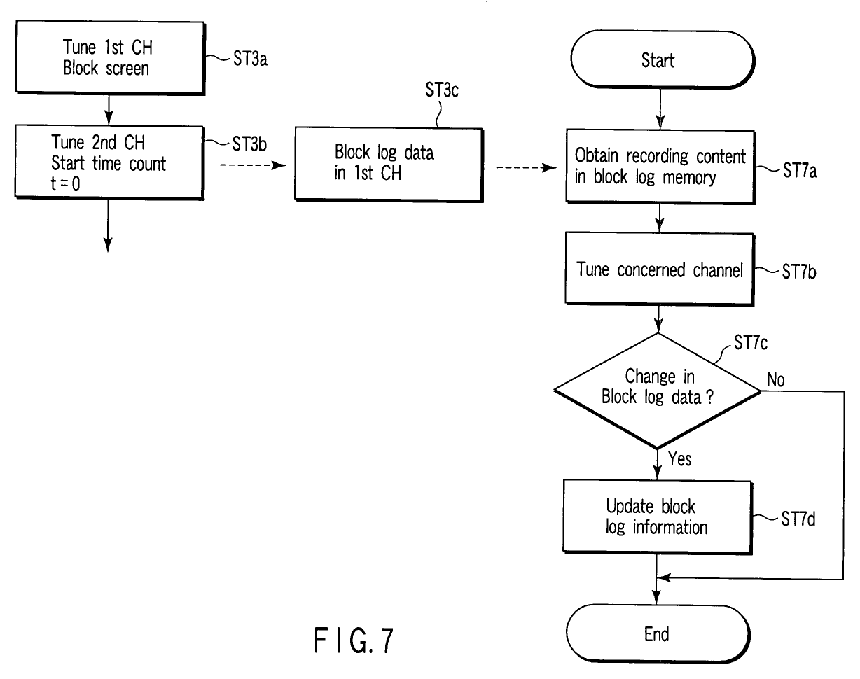

FIG. 7 is an exemplary flowchart showing the procedures and its contents of the screen block control by the control unit 17B. In FIG. 7, the same processing as those of FIG. 3 will be eliminated in explanation.

It is assumed that the control unit 17B controls to record the block log information showing the fact of the screen block in relation to the first channel when the tuned first channel is in the screen block state and is changed to the second channel.

The control unit 17B acquires the block log information from the block log memory 21 in parallel with processing from the step ST3a to the step 3j in FIG. 3 (step ST7a), makes the unused demodulator 32 tune the first channel which has been in the screen block state in accordance with the acquired block log information (step ST7b) and determines whether or not the screen block log information has changed, based on the received rating information to be decoded by the data slicer 33 (step ST7c).

Here, if the screen block log information has changed (Yes, in step ST7c), the control unit 17B updates the content of the block log information stored in the block log memory 21 (step ST7d). Otherwise stated (No, in step ST7c), the control unit 17B terminates the processing and makes a shift to the processing in the forgoing step ST7a.

According to the second embodiment as mentioned above, even if the user changes the channel to be viewed and tunes again the channel of which the screen has been formerly blocked, the broadcast receiver 1 can immediately execute the screen block of the corresponding channel by using the block log information stored in the block log memory 21. And also the broadcast receiver 1 can constantly and timely rewrite the block log information stored in the block log memory 21 to the update information by the control unit 17B.

Therefore, the broadcast receiver 1 can block the screen, based on the renewal block log information stored in the block log memory 21.

### Other Embodiment

The present invention is not limited to each embodiment just as described above, and in the stage of the implementation, it is obvious that modifications and concrete variations of the present invention are available without departing from the spirit and or scope of the invention. It is further understood that a variety of inventions can be formed by appropriately combining a plurality of constituent elements disclosed in the foregoing embodiments. For example, some of the constituent elements may be eliminated from the entire constituent elements shown in the embodiments. Furthermore, the constituent elements extending over the different embodiments may be combined appropriately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A television receiver configured to extract rating information indicating a degree of extreme of a program content corresponding to a channel tuned by a tuning unit among television broadcast signals in a plurality of channels, compare the rating information to pre-registered rating information and perform screen block to make the program displayed on a display unit again impossible to be viewed, based on a comparison result, comprising:
a recorder which records block log information relating to the screen block to a recording medium in relation to a first channel, when the first channel displayed on the display unit is in a screen block state; and
a controller which reads out the block log information of the first channel from the recording medium and performs screen block of a program displayed on the display unit, based on the block log information, when the first channel is tuned after a second channel different from the first channel is tuned from the first channel by the tuning unit.

2. The television receiver according to claim 1, wherein the controller comprises:
a timer which counts a time required from extraction of the rating information until execution of the screen block;
a starting unit to start the timer when the second channel is tuned from the first channel by the tuning unit;
a detector which detects the fact that the second channel has been changed into the first channel within a time period counted by the timer; and
a display controller which reads out the block log information of the first channel when the fact the second channel has been changed into the first channel is detected, and performs screen block of a program displayed on the display unit, based on the block log information.

3. The television receiver according to claim 2, wherein the display controller displays program of the first channel onto the display unit when it is detected that the second channel has been changed into the first channel after elapse of the time counted by the timer.

4. The television receiver according to claim 1, wherein the recorder records the block log information to the recording medium in relation to the first channel when the second channel is tuned from the first channel by the tuning unit.

5. A television receiver comprising a first receiving unit to extract rating information indicating a degree of extreme of a program content corresponding to a channel tuned by a tuning unit among television broadcast signals in a plurality of channels, compare the rating information to pre-registered rating information and perform screen block so as to make the corresponding program displayed on a display unit impossible to be viewed on the basis of a comparison result; and a second receiving unit to extract rating information corresponding to a channel different form that of the first channel and compare the rating information to the pre-registered rating information comprising:
a recorder which records block log information relating to screen block in a recording medium in relation to the first channel when a program in the first channel displayed onto the display unit is in a screen block state;
a controller which reads out the block log information of the first channel from the recording medium and performs screen block of a program displayed on the display unit, based on the block log information, when the first channel is tuned after a second channel different from the first channel is tuned by the tuning unit; and
an updating unit to update a recorded content of the block log information on the recording medium after recording of the block log information by the recorder, based on a comparison result of rating information acquired from an unused receiving unit among the first and the second receiving units.

6. The television receiver according to claim 5, wherein the controller comprises:
a timer which counts a time required from extraction of the rating information until execution of the screen block;
a starting unit to start the timer when the second channel is tuned from the first channel by the tuning unit;
a detector which detects the fact that the second channel has been changed into the first channel within a time period counted by the timer; and
a display controller which reads out the block log information of the first channel when the fact the second channel has been changed into the first channel is detected and performs screen block of a program displayed on the display unit, based on the block log information.

7. The television receiver according to claim 6, wherein the display controller displays a program of the first channel onto the display unit when it is detected that the second channel has been changed to the first channel after elapse of a time period counted by the timer.

8. The television receiver according to claim 5, wherein the recorder records the block log information to the recording medium in relation to the first channel when the second channel is tuned from the first channel by the tuning unit.

9. The television receiver according to claim 5, wherein the update unit comprises a tuning controller which makes an unused receiving unit among the first and the second receiving units tune the first channel meeting with the block log information on the recording medium.

10. A control method for television receiver which extracts rating information indicating a degree of extreme of a program content corresponding to a channel tuned by a tuning unit among television broadcast signals in a plurality of channels, compares the extracted rating information to pre-registered rating information and performs screen block to make a program displayed on a display unit impossible to be viewed, based on a comparison result, comprising:
recording block log information relating to screen block to a recording medium in association with a first channel when the first channel displayed on the display unit is in a screen block state; and
reading out the block log information of the first channel from the recording medium and performing screen block of a program displayed on the display unit, based on the block log information, when the first channel is tuned after a second channel different from the first channel is tuned from the first channel by the tuning unit.
